(19) United States
(12) Patent Application Publication
(10) Pub. No.: US 2012/0155661 A1
(43) Pub. Date: Jun. 21, 2012

(54) ELECTRONIC DEVICE AND METHOD FOR TESTING AN AUDIO MODULE

(75) Inventors: SHOU-HENG MA, Shenzhen City (CN); DE-HUA DANG, Shenzhen City (CN); SHUANG PENG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/171,473

(22) Filed: Jun. 29, 2011

(30) Foreign Application Priority Data
Dec. 21, 2010 (CN) 201010598907.4

(51) Int. Cl. H04R 29/00

(52) U.S. Cl. 381/58

(57) ABSTRACT

An electronic device and method for testing an audio module of a network device including establishing a first connection between an audio output interface of the electronic device and a microphone interface of the network device. First audio data of a test file is transmitted from the audio output interface to the microphone interface through the first connection. An audio card of the network device records the first audio data output by the microphone interface to generate second audio data, and transmit the second audio data to the electronic device through a network. The second audio data is compared with the first audio data in response to receiving the second audio data by the electronic device. The audio module is determined to be normal if the second audio data matches the first audio data.

### BACKGROUND

1. Technical Field

Embodiments of the present disclosure relate to testing technology, and more particularly to an electronic device and method for testing an audio module using the electronic device.

2. Description of Related Art

Audio modules may be equipped in different kinds of electronic devices, such as a pan, tilt and zoom (PTZ) network camera. The electronic devices may utilize the audio modules to record and output audio data. For example, the PTZ network camera may be used to monitor a specific position (e.g., a warehouse) to ensure security surveillance. The PTZ network camera having the audio module may record sounds of the specific position. It is important to ensure quality of the audio module in the PTZ network camera before monitoring the specific position. Thus, an electronic device and method for testing an audio module of a network device are desired.

### BRIEF DESCRIPTION OF THE DRAWINGS

FIG. 1 is a block diagram of one embodiment of an electronic device in communication with a network device.

FIG. 2 is a block diagram of one embodiment of the electronic device including an audio module testing system.

FIG. 3 is a flowchart of a first embodiment of a method for testing an audio module of the network device using the electronic device of FIG. 2.

FIG. 4 is a flowchart of a second embodiment of a method for testing an audio module of the network device using the electronic device of FIG. 2.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

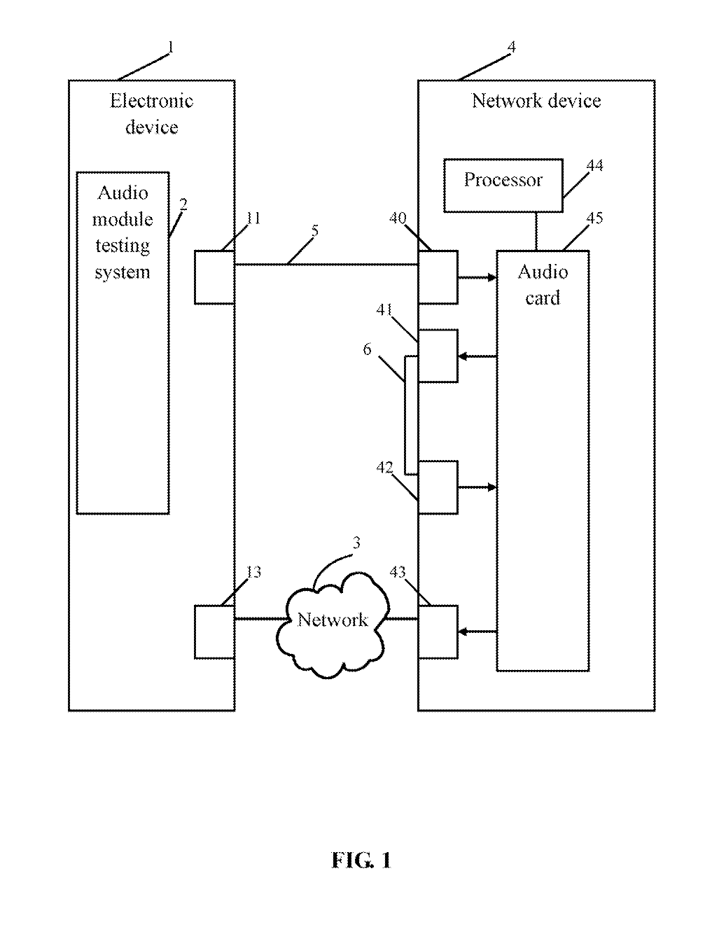

FIG. 1 is a block diagram of one embodiment of an electronic device 1 in communication with a network device 4. The electronic device 1 includes an audio module testing system 2. The audio module testing system 2 may be used to test an audio module of the network device 4 to determine if the audio module is normal. Detailed descriptions are provided below.

In some embodiments, the electronic device 1 may be a computer, a notebook computer, a computer server, a communication device, or any other computing device. The electronic device 1 includes an audio output interface 11 and a network interface 13. The network device 4 may be a network camera (e.g., an Internet Protocol camera, a pan, tilt and zoom (PTZ) network camera), a mobile phone, or any other electronic device including an audio module. In some embodiments, the audio module of the network device 4 may include, but is not limited to, a microphone interface 40, an audio output interface 41, an audio input interface 42, a network interface 43, and an audio card 45. The audio module may also include other components that relates to audio processing function. Detailed descriptions of above mentioned interfaces of the electronic device 1 and the network device 4 are provided below.

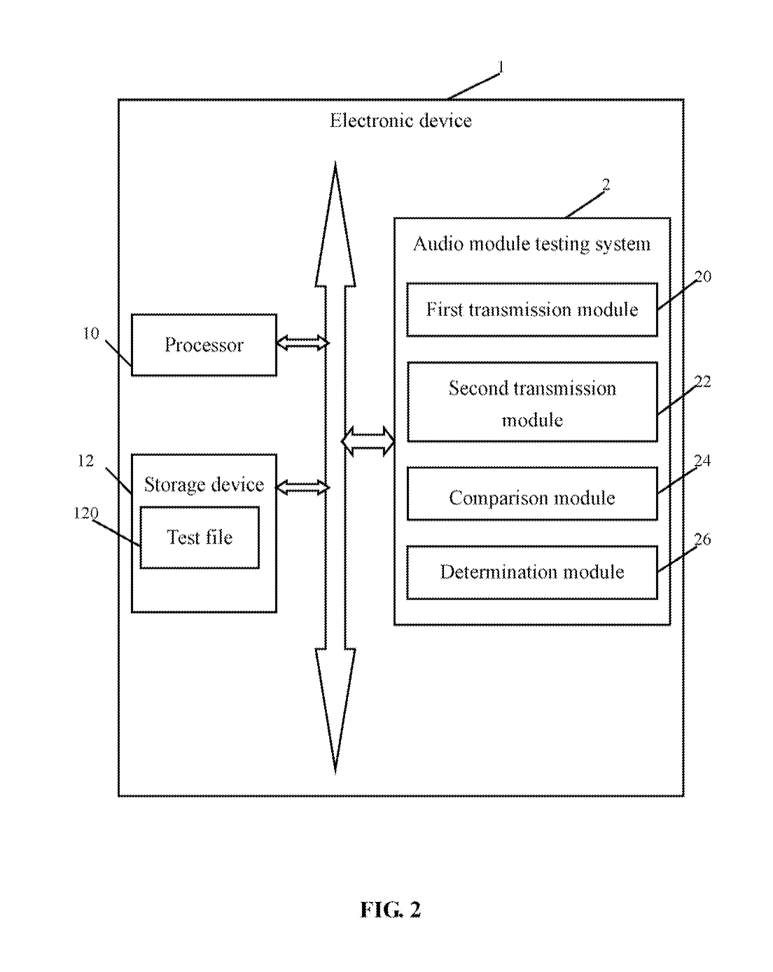

FIG. 2 is a block diagram of one embodiment of the electronic device 1 including the audio module testing system 2. The electronic device 1 also includes at least one processor 10 and a storage device 12. The at least one processor 10 executes one or more computerized operations of the electronic device 1 and other applications, to provide functions of the electronic device 1. The storage device 12 stores one or more programs, such as programs of the operating system, other applications of the electronic device 1, and various kinds of data, such as a test file 120. In some embodiments, the storage device 12 may include a memory of the electronic device 1 and/or an external storage card, such as a memory stick, a smart media card, a compact flash card, or any other type of memory card.

In some embodiments, the audio module testing system 2 includes a first transmission module 20, a second transmission module 22, a comparison module 24, and a determination module 26. The modules 20, 22, 24 and 26 may include computerized codes in the form of one or more programs stored in the storage device 12. The computerized codes include instructions executed by the at least one processor 10 to provide functions for modules 20, 22, 24 and 26. Details of these functions follow.

In some embodiments, before using the audio module testing system 2 to test the audio module of the network device 4, the audio output interface 11 of the electronic device 1 is connected to the microphone interface 40 using a first audio cable 5 (as shown in FIG. 1). Hereinafter, a connection between the audio output interface 11 and the microphone interface 40 is referred to as a first connection.

The first transmission module 20 outputs first audio data of the test file 120 using the audio output interface 11, and transmits the first audio data to the microphone interface 40 of the network device 4 through the first connection. The test file 120 may be an audio file, such as a song, and/or prerecorded sounds, for example. The first audio data of the test file 120 may be original audio data of the test file 120, the first audio data is used to compare with following processed audio data (detailed descriptions are provided below).

The microphone interface 40 outputs the first audio data received from the electronic device 1. The audio card 45 of the network device 4 records the first audio data output by the microphone interface 40, and generates second audio data according to the recorded first audio data. The audio card 45 of the network device 4 further transmits the second audio data to the network interface 13 of the electronic device 1 through a network 3 using the network interface 43 of the network device 4. The network 3 may be the Internet, the intranet, or other kind of communication network.

The second transmission module 22 receives the second audio data from the network device 4 through the network interface 13 of the electronic device 1.

The comparison module 24 compares the second audio data with the first audio data to determine if the second audio data matches the first audio data. The comparison module 24 may process the second audio data using a fast Fourier transform (FFT) algorithm to acquire various audio parameters of the second audio data, such as a signal-noise rate, an audio frequency, a time length, a degree of distortion, for example.

In some embodiments, the comparison module 24 compares the second audio data and the first audio data by comparing audio frequencies and time lengths of the second audio data and the first audio data. In some embodiments, an audio frequency of the first audio data of the test file may be predetermined to be 1000 Hz, and a corresponding time length is 1 minute. In other embodiments, the comparison module 24 may compare the second audio data and the first audio data using other audio parameters.

If the audio frequencies and the time lengths of the second audio data and the first audio data are the same, the comparison module 24 determines that the second audio data matches the first audio data. If the audio frequencies or the time lengths of the second audio data and the first audio data are different, the comparison module 24 determines that the second audio data does not match the first audio data.

If the second audio data matches the first audio data, the determination module 26 determines that the audio module is normal. If the second audio data does not match the first audio data, the determination module 26 determines that the audio module is abnormal.

In other embodiments, the audio module testing system 2 may perform more tests to ensure the quality of the audio module of the network device 4. For example, the audio input interface 41 and the audio output interface 42 of the network device are connected using a second audio cable. Hereinafter, a connection between the audio input interface 41 and the audio output interface 42 is referred to as a second connection.

To perform a further test of the audio module, the second transmission module 22 transmits the second audio data from the electronic device 1 back to the network device 4 through the network 3.

When the network interface 43 of the network device 4 receives the second audio data, the audio card 45 plays the second audio data to generate third audio data, and outputs the third audio data using the audio output interface 41 of the network device. The audio input interface 42 receives the third audio data through the second connection, and transmit the third audio data to the audio card 45. Then the audio card 45 transmits the third audio data to the electronic device 1 through the network 3 using the network interfaces 43 and 13.

The above mentioned procedure may determine if any distortion is happened to transmission audio data (e.g., the second and third audio data).

The second transmission module 22 receives the third audio data from the network device 4 through the network 3. The comparison module 24 compares the third audio data with the first audio data. For example, the comparison module 24 may compare audio frequencies and time lengths of the third audio data and the first audio data. If the audio frequencies and time lengths of the third audio data and the first audio data are the same, the comparison module 24 determines that the third audio data matches the first audio data. If the audio frequencies or time lengths of the third audio data and the first audio data are different, the comparison module 24 determines that the third audio data does not match the first audio data.

If the third audio data matches the first audio data, the determination module 26 determines that the audio module is normal. If the third audio data does not match the first audio data, the determination module 26 determines that the audio module is abnormal.

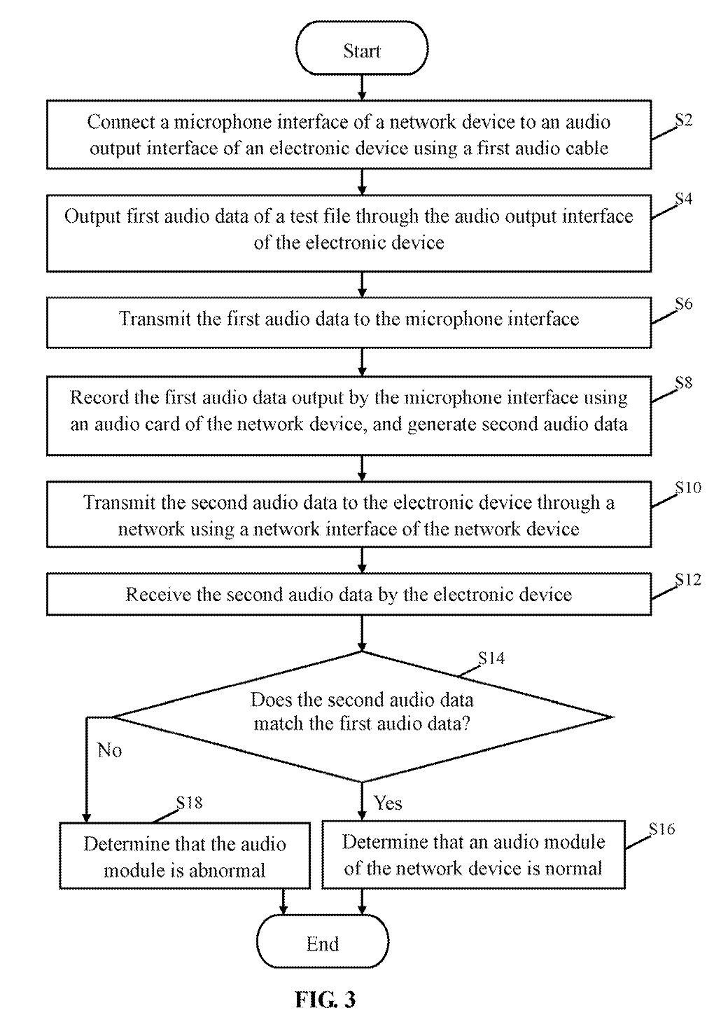

FIG. 3 is a flowchart of a first embodiment of a method for testing an audio module of the network device using the electronic device of FIG. 2. Depending on the embodiment, additional blocks may be added, others removed, and the ordering of the blocks may be replaced.

In block S2, the audio output interface 11 of the electronic device 1 is connected to the microphone interface 40 using a first audio cable 5. As mentioned above, a connection between the audio output interface 11 and the microphone interface 40 is referred to as a first connection.

In block S4, the first transmission module 20 outputs first audio data of the test file 120 using the audio output interface 11.

In block S6, the first transmission module 20 transmits the first audio data to the microphone interface 40 of the network device 4 through the first connection.

In block S8, the microphone interface 40 outputs the first audio data received from the electronic device 1, and the audio card 45 of the network device 4 records the first audio data output by the microphone interface 40, and generates second audio data according to the recorded first audio data.

In block S10, the audio card 45 of the network device 4 transmits the second audio data to the network interface 13 of the electronic device 1 through a network 3 using the network interface 43 of the network device 4.

In block S12, the second transmission module 22 receives the second audio data from the network device 4 through the network interface 13 of the electronic device 1.

In block S14, the comparison module 24 compares the second audio data with the first audio data to determine if the second audio data matches the first audio data.

As mentioned above, if the audio frequencies and the time lengths of the second audio data and the first audio data are the same, the comparison module 24 determines that the second audio data matches the first audio data, and the procedure goes to block S16. If the audio frequencies or the time lengths of the second audio data and the first audio data are different, the comparison module 24 determines that the second audio data does not match the first audio data, and the procedure goes to block 518.

In block S16, the determination module 26 determines that the audio module is normal.

In block S18, the determination module 26 determines that the audio module is abnormal.

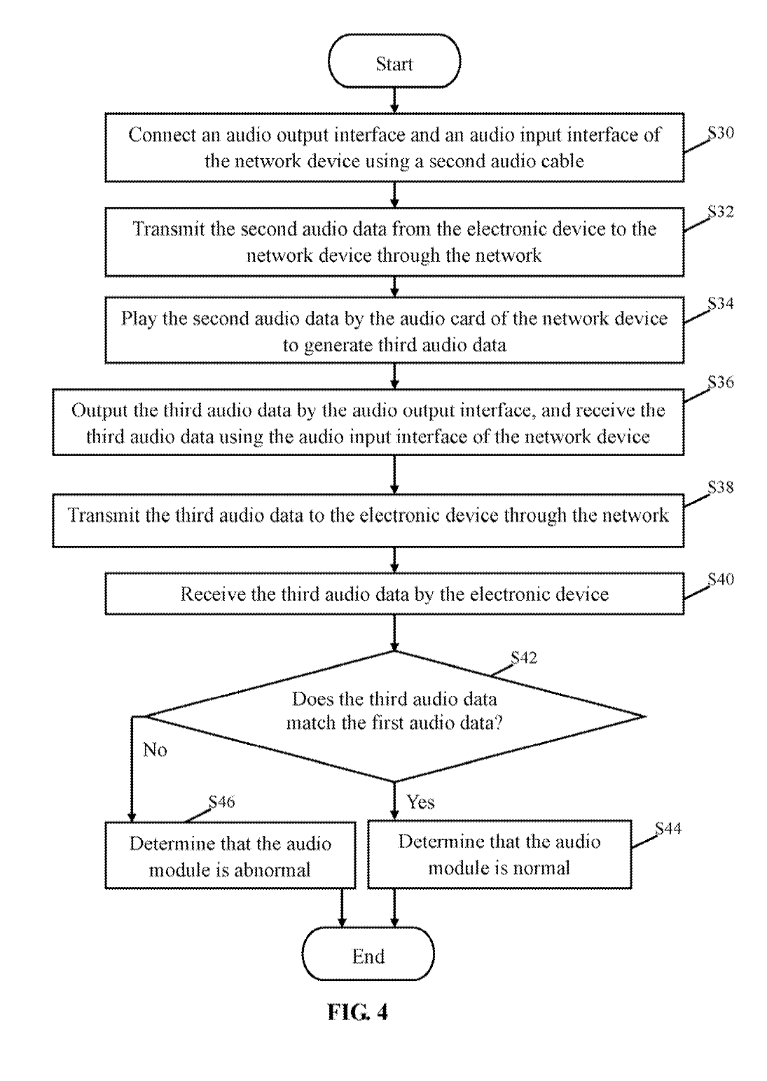

FIG. 4 is a flowchart of a second embodiment of a method for testing an audio module of the network device using the electronic device of FIG. 2. Depending on the embodiment, additional blocks may be added, others removed, and the ordering of the blocks may be replaced.

In the second embodiment, after block S14 in FIG. 3 is executed, if the comparison module 24 determines that the second audio data matches the first audio data, the procedure goes to block S30 in FIG. 4 to do more test on the audio module of the network device 4.

In block S30, the audio input interface 41 and the audio output interface 42 of the network device are connected using a second audio cable. As mentioned above, a connection between the audio input interface 41 and the audio output interface 42 is referred to as a second connection.

In block S32, the second transmission module 22 transmits the second audio data from the electronic device 1 back to the network device 4 through the network 3.

In block S34, the network interface 43 of the network device 4 receives the second audio data, and the audio card 45 plays the second audio data to generate third audio data.

In block S36, the audio card 45 outputs the third audio data using the audio output interface 41 of the network device, and the audio input interface 42 receives the third audio data through the second connection, and transmits the third audio data to the audio card 45.

In block S38, the audio card 45 transmits the third audio data to the electronic device 1 through the network 3 using the network interfaces 43 and 13.

In block S40, the second transmission module 22 receives the third audio data from the network device 4 through the network 3.

In block S42, the comparison module 24 compares the third audio data with the first audio data. As mentioned above, if audio frequencies and time lengths of the third audio data and the first audio data are the same, the comparison module 24 determines that the third audio data matches the first audio data, and the procedure goes to block S44.

If the audio frequencies or time lengths of the third audio data and the first audio data are different, the comparison module 24 determines that the third audio data does not match the first audio data, and the procedure goes to block S46.

In block S44, the determination module 26 determines that the audio module is normal.

In block S46, the determination module 26 determines that the audio module is abnormal.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A method for testing an audio module of a network device using an electronic device, the audio module comprising a microphone interface, an audio card and a network interface, the microphone interface having a first connection to an audio output interface of the electronic device through a first audio cable, the method comprising:
transmitting first audio data of a test file from the audio output interface to the microphone interface through the first connection, the audio card of the network device recording the first audio data output by the microphone interface to generate second audio data and transmitting the second audio data to the electronic device through a network using the network interface of the network device;
receiving the second audio data from the network device;
comparing the second audio data with the first audio data; and
determining that the audio module is normal under the condition that the second audio data matches the first audio data.

2. The method according to claim 1, further comprising:
determining that the audio module is abnormal under the condition that the second audio data does not match the first audio data.

3. The method according to claim 1, wherein the step of comparing the second audio data and the first audio data comprises:
comparing audio frequencies and time lengths of the second audio data and the first audio data;
determining that the second audio data matches the first audio data if the audio frequencies and the time lengths of the second audio data and the first audio data are the same; or
determining that the second audio data does not match the first audio data if the audio frequencies or the time lengths of the second audio data and the first audio data are different.

4. The method according to claim 1, wherein the audio module of the network device further comprises an audio output interface and an audio input interface, and the audio output interface has a second connection to the audio input interface through a second audio cable.

5. The method according to claim 4, further comprising:
transmitting the second audio data from the electronic device to the network device through the network, the audio card of the network device outputting the second audio data to generate third audio data using the audio output interface of the network device, receiving the third audio data using the audio input interface through the second connection, and transmitting the third audio data to the electronic device through the network.

6. The method according to claim 5, further comprising:
receiving the third audio data by the electronic device through the network;
comparing the third audio data with the first audio data;
determining that the audio module is normal under the condition that the third audio data matches the first audio data; or
determining that the audio module is abnormal under the condition that the third audio data does not match the first audio data.

7. An electronic device for testing an audio module of a network device, the audio module comprising a microphone interface, an audio card and a network interface, the electronic device comprising:
an audio output interface having a first connection to the microphone interface of the network device through a first audio cable;
a storage device;
at least one processor; and
one or more programs stored in the storage device and being executable by the at least one processor, the one or more programs comprising:
a first transmission module operable to transmit first audio data of a test file from the audio output interface to the microphone interface of the network device through the first connection, the audio card of the network device recording the first audio data output by the microphone interface to generate second audio data and transmitting the second audio data to the electronic device through a network using the network interface of the network device;
a second transmission module operable to receive the second audio data from the network device;
a comparison module operable to compare the second audio data with the first audio data; and
a determination module operable to determine that the audio module is normal under the condition that the second audio data matches the first audio data.

8. The electronic device according to claim 7, wherein the determination is further operable to determine that the audio module is abnormal under the condition that the second audio data does not match the first audio data.

9. The electronic device according to claim 7, wherein the comparison module compares the second audio data and the first audio data by comparing audio frequencies and time lengths of the second audio data and the first audio data, determines that the second audio data matches the first audio data if the audio frequencies and the time lengths of the second audio data and the first audio data are the same, or determines that the second audio data does not match the first audio data if the audio frequencies or the time lengths of the second audio data and the first audio data are different.

10. The electronic device according to claim 7, wherein the audio module of the network device further comprises an audio output interface and an audio input interface, and the audio output interface has a second connection to the audio input interface through a second audio cable.

11. The electronic device according to claim 10, wherein the second transmission module is further operable to transmit the second audio data from the electronic device to the network device through the network, the audio card of the network device outputs the second audio data to generate third audio data using the audio output interface of the network device, receive the third audio data using the audio input interface through the second connection, and transmit the third audio data to the electronic device through the network.

12. The electronic device according to claim 11, wherein:
the second transmission module is further operable to receive the third audio data through the network;
the comparison module is further operable to compare the third audio data with the first audio data; and
the determination module is further operable to determine that the audio module is normal under the condition that the third audio data matches the first audio data, or determine that the audio module is abnormal under the condition that the third audio data does not match the first audio data.

13. A storage medium storing a set of instructions, the set of instructions capable of being executed by a processor to perform a method for testing an audio module of a network device using an electronic device, the audio module comprising a microphone interface, an audio card and a network interface, the microphone interface having a first connection to an audio output interface of the electronic device through a first audio cable, the method comprising:
transmitting first audio data of a test file from the audio output interface to the microphone interface through the first connection, the audio card of the network device recording the first audio data output by the microphone interface to generate second audio data and transmitting the second audio data to the electronic device through a network using the network interface of the network device;
receiving the second audio data from the network device;
comparing the second audio data with the first audio data; and
determining that the audio module is normal under the condition that the second audio data matches the first audio data.

14. The storage medium as claimed in claim 13, wherein the method further comprises:
determining that the audio module is abnormal under the condition that the second audio data does not match the first audio data.

15. The storage medium as claimed in claim 13, wherein the step of comparing the second audio data and the first audio data comprises:
comparing audio frequencies and time lengths of the second audio data and the first audio data;
determining that the second audio data matches the first audio data if the audio frequencies and the time lengths of the second audio data and the first audio data are the same; or
determining that the second audio data does not match the first audio data if the audio frequencies or the time lengths of the second audio data and the first audio data are different.

16. The storage medium as claimed in claim 13, wherein the audio module of the network device further comprises an audio output interface and an audio input interface, and the audio output interface has a second connection to the audio input interface through a second audio cable.

17. The storage medium as claimed in claim 16, wherein the method further comprises:
transmitting the second audio data from the electronic device to the network device through the network, the audio card of the network device outputting the second audio data to generate third audio data using the audio output interface of the network device, receiving the third audio data using the audio input interface through the second connection, and transmitting the third audio data to the electronic device through the network.

18. The storage medium as claimed in claim 17, wherein the method further comprises:
receiving the third audio data by the electronic device through the network;
comparing the third audio data with the first audio data;
determining that the audio module is normal under the condition that the third audio data matches the first audio data; or
determining that the audio module is abnormal under the condition that the third audio data does not match the first audio data.
